(19) United States
(12) Patent Application Publication
(10) Pub. No.: US 2025/0070464 A1
(43) Pub. Date: Feb. 27, 2025

(54) TERMINAL REAR COVER AND ELECTRONIC DEVICE

(71) Applicant: BEIJING XIAOMI MOBILE SOFTWARE CO., LTD., Beijing (CN)

(72) Inventor: Lupeng ZHANG, Beijing (CN)

(21) Appl. No.: 18/719,601

(22) PCT Filed: Apr. 29, 2022
(86) PCT No.: PCT/CN2022/090798

§ 371 Date: Jun. 13, 2024

(30) Foreign Application Priority Data
Dec. 22, 2021 (CN) 202111608369.7

(51) Int. Cl. H01Q 5/25; H01Q 1/24; H01Q 1/48

(52) U.S. Cl. CPC H01Q 5/25; H01Q 1/243; H01Q 1/48

(57) ABSTRACT

A terminal rear cover includes: a rear cover body including an opening; a metal decoration frame coupled to the rear cover body and covering the opening, the metal decoration frame including a groove and at least one light passing opening, the groove being spaced from each light passing opening; and a UWB antenna embedded in the groove.

### CROSS-REFERENCE TO RELATED APPLICATION

The present application is a National Stage of International Patent Application No. PCT/CN2022/090798, filed on Apr. 29, 2022, which claims the benefit of priority of Chinese Patent Application No. 202111608369.7, filed on Dec. 22, 2021, both of which are incorporated by reference herein in their entireties for all purposes.

### BACKGROUND

In recent years, with the maturity of UWB technology solutions and cost reduction, and based on the accurate indoor positioning function of UWB technology, major manufacturers are trying to apply UWB antennas to the user's daily needs of terminal devices, such as mobile phone terminals.

### SUMMARY

The present disclosure relates to the field of terminal technologies, and in particular to a terminal rear cover and an electronic device.

According to a first aspect of embodiments of the present disclosure, there is provided a terminal rear cover, including: a rear cover body including an opening; a metal decoration frame coupled to the rear cover body and covering the opening, the metal decoration frame including a groove and at least one light passing opening, and the groove being spaced from each light passing opening; and a UWB antenna embedded in the groove.

According to a second aspect of embodiments of the present disclosure, there is provided an electronic device, including: a camera module including at least one lens; and a terminal rear cover as described in any of above embodiments, each light passing opening is arranged corresponding to at least one lens.

### BRIEF DESCRIPTION OF THE DRAWINGS

The drawings herein are incorporated into the specification and form part of the specification, show embodiments conforming to the present disclosure and are used together with the description to explain the principles of the present disclosure.

FIG. 1 is a schematic diagram of a terminal rear cover illustrated according to an embodiment.

FIG. 2 is a schematic cross-sectional diagram of a terminal rear cover illustrated according to an embodiment.

FIG. 3 is a radiation gain diagram of a UWB antenna in FIG. 1.

FIG. 4 is a schematic diagram of an assembly of a metal decoration frame and a UWB antenna illustrated according to an embodiment.

FIG. 5 is a schematic diagram of an assembly of another metal decoration frame and a UWB antenna illustrated according to an embodiment.

FIG. 6 is a schematic top view of a UWB antenna illustrated according to an embodiment.

FIG. 7 is a schematic top view of an electronic device illustrated according to an embodiment.

FIG. 8 is a side view of the electronic device in FIG. 7.

### DETAILED DESCRIPTION OF THE DISCLOSURE

Illustrative embodiments are described in detail here, and examples are illustrated in the accompanying drawings. When the following description relates to drawings, the same number in different drawings represents the same or similar elements, unless otherwise indicated. The embodiments described in the following illustrative embodiments do not represent all embodiments consistent with the present disclosure. Rather, they are only examples of devices and methods that are consistent with some aspects of the present disclosure, as detailed in the attached claims.

The terms used in the present disclosure are intended solely to describe specific embodiments and are not intended to limit the present disclosure. The singular forms “a”, “the” and “this” used in the present disclosure and the attached claims are also intended to include the plural forms, unless the context clearly indicates otherwise. It should also be understood that the term “and/or” as used herein refers to and encompasses any or all possible combinations of one or more associated listed items.

It should be understood that, although the terms first, second, third, etc. may be used in the present disclosure to describe various types of information, such information should not be limited to these terms. These terms are only used to distinguish the same type of information from each other. For example, the first information may also be referred to as the second information without departing from the scope of the present disclosure, and similarly, the second information may also be referred to as the first information. Depending on the context, the word “if” as used herein may be interpreted as “when . . . ” or “upon . . . or “in response to determining”.

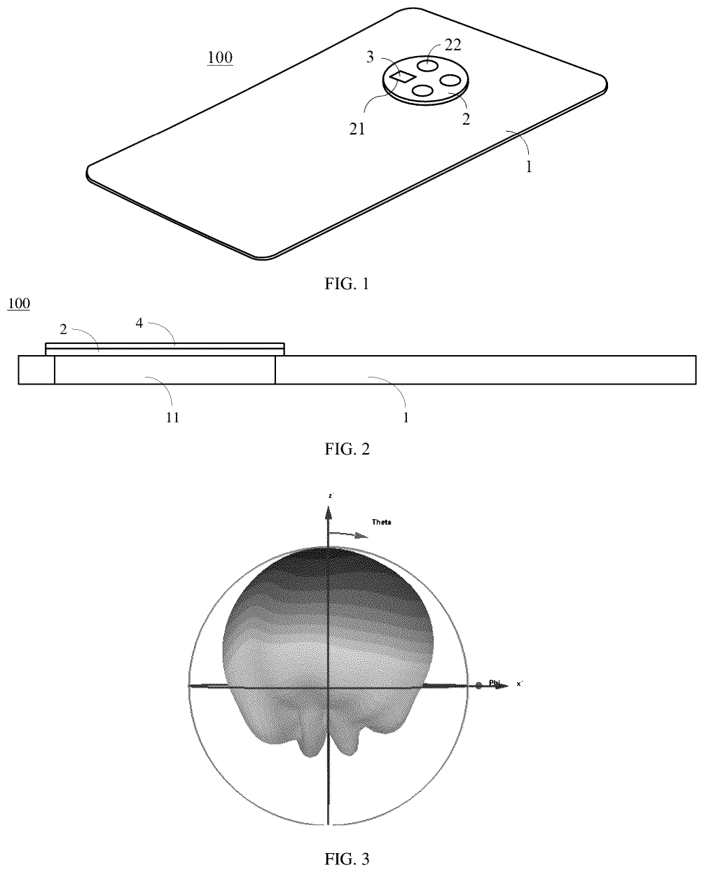

FIG. 1 is a schematic diagram of a terminal rear cover 100 illustrated according to an embodiment. FIG. 2 is a schematic cross-sectional diagram of a terminal rear cover 100 illustrated according to an embodiment. FIG. 3 is a schematic diagram of an assembly of a metal decoration frame 2 and a UWB (Ultra Wide Band, UWB) antenna 3 according to an embodiment.

As illustrated in FIGS. 1 and 2, the terminal rear cover 100 may include a rear cover body 1, a metal decoration frame 2 and a UWB antenna 3, and the metal decoration frame 2 may be coupled to the rear cover body 1 to decorate a camera module of an electronic device that arranged at the terminal rear cover 100 through the metal decoration frame 2. The rear cover body 1 may include an opening 11, the opening 11 may penetrate through the rear cover body 1, leaving space for the assembly of the metal decoration frame 2, and the opening 11 may be in a shape of a ring or a square or any other shape, which is not limited by the present disclosure. The rear cover body 1 may include a metal rear cover body, a plastic rear cover body, or a glass rear cover body, and the present disclosure does not limit this. The metal decoration frame 2 may be coupled to the rear cover body 1 and the opening 11 may be covered by the metal decoration frame 2. For example, the metal decoration frame 2 may be coupled to an inner ring of the opening 11, or the metal decoration frame 2 may be coupled to an outer side of rear cover body 1 surrounding the opening 11. The metal decoration frame 2 may include a groove 21 and at least one light passing opening 22, the groove 21 is spaced from each light passing opening 22, and the UWB antenna 3 may be embedded in the groove 21.

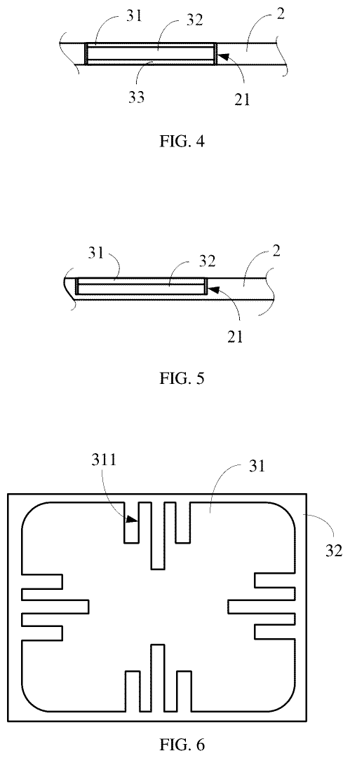

As illustrated in FIG. 4, the UWB antenna 3 may be embedded in the groove 21 and assembled with the metal decoration frame 2, and in a depth direction of the light passing opening 22, an orthogonal projection of each light passing opening 22 may be separated from an orthogonal projection of the UWB antenna 3. That is, the UWB antenna 3 will not cover the light passing opening 22, and the UWB antenna 3 is prevented from blocking the light through the light passing opening 22 and then affecting imaging of the electronic device provided with the terminal rear cover 100. In technical solutions of the present disclosure, the UWB antenna 3 is arranged on the metal decoration frame 2 of the terminal rear cover 100. Based on this, when the terminal rear cover 100 is arranged on the electronic device, the metal decoration frame 2 is usually a last layer of metal structure on a back of the electronic device, and there is no longer any blocking from other metal parts, so that the blocking from other metal parts may be prevented from influencing on radiation of the UWB antenna 3, and at the same time, relative to the related art, the influence of the metal decoration frame 2 itself on the gain in all directions when the UWB antenna 3 radiates outwards may be avoided. For example, as illustrated in FIG. 3, the gain varies smoothly in all directions over a space of 180° of the UWB antenna facing outward, without distortion.

In some embodiments, as illustrated in FIG. 4, the groove 21 may include a through groove, and the through groove may penetrate along a depth direction of the light passing opening or a height direction of the metal decoration frame 2. The UWB antenna 3 may include a conductive unit 31, a dielectric substrate 32 and a metal grounding plate 33. The conductive unit 31 may be arranged at a side of the dielectric substrate 32, and the metal grounding plate 33 may be arranged at a side of the dielectric substrate 32 facing away from the conductive unit 31. Based on the through groove, the UWB antenna 3 may be arranged in the through groove, and the metal grounding plate 33 is exposed relative to the rear cover body 1, so that the metal grounding plate 33 is conveniently grounded.

In other embodiments, as illustrated in FIG. 5, the UWB antenna 3 may include a conductive unit 31 and a dielectric substrate 32, and the conductive unit 31 may be arranged at a side of the dielectric substrate 32. The groove body 21 may include a recess, and an opening direction of recess is toward an inner side or an outer side of the terminal rear cover 100. The UWB antenna 3 is arranged in the recess, and a bottom wall of the groove may be attached to a side of the dielectric substrate 32 facing away from the conductive unit 31, so that attachment of the UWB antenna 3 with the metal decoration frame 2 may be realized. The UWB antenna 3 may be grounded through the metal decoration frame 2, facilitating simplification of the structure of the UWB antenna 3 itself.

In above various embodiments, the dielectric substrate 32 may include a liquid crystal polymer substrate. The liquid crystal polymer substrate may maintain substantially the same dielectric constant at a variety of frequencies, and the consistency is relatively good. One or a plurality of identical conductive units 31 may be arranged on the same dielectric substrate 32. The plurality of conductive units 31 may be spaced from each other. As illustrated in FIG. 6, the conductive unit 31 may include a plurality of elongated grooves 311 recessed inwardly from an edge. For example, in FIG. 6, assuming that the conductive unit 31 is substantially in a square shape, each edge of the conductive unit 31 may be provided with an elongated groove 311 recessed inwardly from the edge. Through the arrangement of the elongated groove 311, it is conducive to extending a length of a current path on the conductive unit 31, which is equivalent to increasing the length of the conductive unit 31 in a horizontal direction or a vertical direction. Therefore, when radiating a signal of a corresponding frequency band through a one-half wavelength mode or other wavelength modes in the horizontal or vertical direction of the conductive unit 31, compared with the solution realized by a physical size, an effective length of the conductive unit 31 is increased through the elongated groove in the present disclosure, which is conducive to the miniaturization of the conductive unit 31 and is more suitable for the solution that the UWB antenna 3 is arranged in a narrow space of the rear cover body 1. In an embodiment illustrated in FIG. 6, for example, the number and size of the elongated grooves 311 formed at each edge of the conductive unit 31 are the same. In fact, in other embodiments, the elongated grooves 311 may also be specifically designed according to the physical size of the conductive unit 31 itself, the frequency band of the required radiation, and the radiation mode adopted, and the number and size of the elongated grooves 311 formed at each edge are not limited in the present disclosure.

In above various embodiments, the terminal rear cover 100 may also include a protective piece 4. The protective piece 4 may be arranged at a side of the metal decoration frame 2 and cover the metal decoration frame 2, and when the terminal rear cover is arranged on the electronic device, the protective piece 4 is located on an outside of the electronic device, so that a lens of a camera module and the metal decoration frame 2 of the electronic device are protected through the protective piece 4, to reduce scratches. In order not to affect the lighting of the camera module, the protective piece 4 may adopt a light transmission protective piece.

At present, an operational frequency band radiated by UWB antenna 3 may be in the internationally specified UWB frequency band. In a UWB frequency band division method, the UWB frequency band may include the frequency band around 3 GHz-9 GHz, and the UWB frequency band may be divided into fifteen channels. A bandwidth of a fourth channel is 1331.2 MHz, a bandwidth of a seventh channel is 1081.6 MHz, a bandwidth of an eleventh channel is 1331.2 MHz, a bandwidth of a fifteenth channel is 1354.97 MHz, and a bandwidth of other channels may be 499.2 MHz. The UWB antenna 3 in the present disclosure may operate in the fifth channel and the ninth channel of the UWB frequency band. A center frequency of the fifth channel may be around 6.5 GHz, and according to the channel division method, the center frequency of the fifth channel may specifically be 6.4896 GHz. A center frequency of the ninth channel is around 8 GHz, and according to the channel division method, the center frequency of the fifth channel may specifically be 7.9872 GHz. Thus the frequency band requirement when carrying out indoor precise positioning through the UWB antenna 3 may be satisfied. The term “around” herein represents a range of plus or minus 0.02 GHz.

In some embodiments, each conductive unit 31 arranged on the dielectric substrate 32 may be in a square shape, an equivalent length of the conductive unit 31 in a first direction is one-half of a wavelength of the center frequency of the fifth channel, an equivalent length of the conductive unit 31 in a second direction is one-half of a wavelength of the center frequency of the ninth channel, and the first direction is substantially perpendicular to the second direction. For example, the first direction may be a left-right direction in FIG. 6, and the second direction may be an up-down direction in FIG. 6. When an elongated groove is defined at the edge of the conductive unit 31, the equivalent length in the first direction should be the length after considering the elongated groove, and similarly, the equivalent length in the second direction should be the length after considering the elongated groove 311. In the case that the conductive unit 31 does not define an elongated groove 311, the equivalent length is related to the physical size of the conductive unit 31 itself.

In above various embodiments, each conductive unit 31 may be substantially in a square shape, and a corner of the conductive unit 31 may be configured to be electrically coupled to a fee end to realize the feeding. The corner of the conductive unit 31 serves as a feed point coupled to the feed end, which is conducive to the flow of current in different directions, so as to cover the fifth channel and the ninth channel in which the UWB antenna 3 operates. When a plurality of conductive units 31 are arranged on the same dielectric substrate 32, the plurality of conductive units 31 may be electrically coupled to the feed ends respectively.

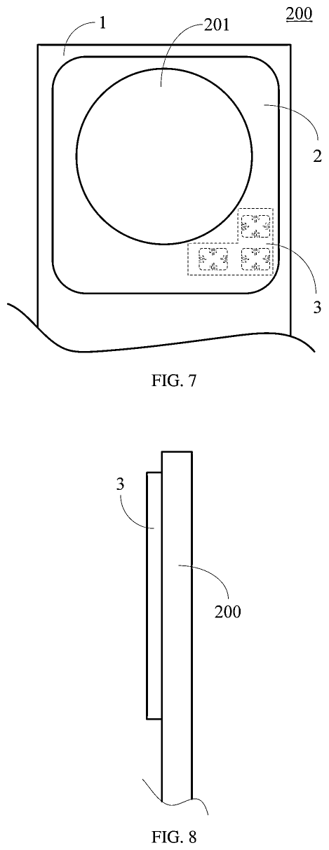

Based on the terminal rear cover 100 disclosed in above various embodiments, as illustrated in FIGS. 7-8, the present disclosure also provides an electronic device 200. The electronic device 200 may include a camera module 201 and a terminal rear cover 100 as described in any of above embodiments. The camera module 201 may include at least one lens, and the light passing opening 22 on the metal decoration frame 2 of the terminal rear cover 100 may be arranged corresponding to one or more lenses. The lens may collect light through the light passing opening for imaging. The electronic device 200 may include a mobile phone terminal, a tablet terminal or a wearable device, etc., and the present disclosure does not limit this.

Embodiments of the present disclosure provide a technical solution that may include the following beneficial effects:

It may be seen from above embodiments that in the technical solution of the present disclosure, the UWB antenna is arranged on the metal decoration frame of the terminal rear cover, based on this, when the terminal rear cover is arranged on the electronic device, because the metal decoration frame is usually the last layer of metal structure on the back of the electronic device, and there is no longer any blocking from other metal parts, so that the blocking from other metal parts may be prevented from influencing on the radiation of the UWB antenna, and at the same time, relative to the related art, the influence of the metal decoration frame itself on the gain in all directions when the UWB antenna radiates outwards may be avoided.

According to a first aspect of embodiments of the present disclosure, there is provided a terminal rear cover, including: a rear cover body including an opening; a metal decoration frame coupled to the rear cover body and covering the opening, the metal decoration frame including a groove and at least one light passing opening, and the groove being spaced from each light passing opening; and a UWB antenna embedded in the groove.

In some embodiments, the UWB antenna includes a conductive unit, a dielectric substrate and a metal grounding plate, the conductive unit is arranged at a side of the dielectric substrate, the metal grounding plate is arranged at an opposite side of the dielectric substrate, the groove includes a through groove, and the UWB antenna is arranged in the through groove.

In some embodiments, the UWB antenna includes a conductive unit and a dielectric substrate, and the conductive unit is arranged at a side of the dielectric substrate; and the groove includes a recess, a bottom wall of the groove is attached to a side of the dielectric substrate facing away from the conductive unit, and the UWB antenna is grounded through the metal decoration frame.

In some embodiments, the conductive unit includes a plurality of elongated grooves recessed inwardly from the at least one side edge.

In some embodiments, the UWB antenna operates in a fifth channel and a ninth channel of a UWB frequency band, a center frequency of the fifth channel is around 6.5 GHz, and a center frequency of the ninth channel is around 8 GHz.

In some embodiments, each conductive unit is substantially in a square shape, an equivalent length of the conductive unit in a first direction is one-half of a wavelength of the center frequency of the fifth channel, an equivalent length of the conductive unit in a second direction is one-half of a wavelength of the center frequency of the ninth channel, and the first direction is substantially perpendicular to the second direction.

In some embodiments, each conductive unit is substantially in a square shape, and a corner of the conductive unit is configured to be electrically coupled to a feed end.

In some embodiments, the dielectric substrate includes a liquid crystal polymer substrate.

In some embodiments, the terminal rear cover further includes: a protective piece arranged at a side of the metal decoration frame, and the protective piece covering the metal decoration frame.

According to a second aspect of embodiments of the present disclosure, there is provided an electronic device, including: a camera module including at least one lens; and a terminal rear cover as described in any of above embodiments, each light passing opening is arranged corresponding to at least one lens.

Those skilled in the art will be apt to think of other embodiments of the present disclosure after considering the disclosure of the description and practice here. The present disclosure is intended to cover any variants, uses, or adaptations of the present disclosure, which follow the general principles of the present disclosure and include common knowledge or customary technical means in the field that are not disclosed in the present disclosure. The description and embodiments are considered illustrative only, and the true scope of the present disclosure is indicated by the claims below.

All embodiments of the present disclosure may be enforced alone or in combination with other embodiments, and shall be deemed to be within the scope of protection of the requirements of the present disclosure.

It should be understood that the present disclosure is not limited to the precise structure already described above and illustrated in the drawings, and may be modified and altered in various ways without departing from its scope. The scope of the present disclosure is limited only by the attached claims.

1. A terminal rear cover, comprising:
a rear cover body comprising an opening;
a metal decoration frame coupled to the rear cover body and covering the opening, the metal decoration frame comprising a groove and at least one light passing opening, and the groove being spaced from each light passing opening; and
a UWB antenna embedded in the groove.

2. The terminal rear cover according to claim 1, wherein the UWB antenna comprises a conductive unit, a dielectric substrate and a metal grounding plate, the conductive unit is arranged at a side of the dielectric substrate, the metal grounding plate is arranged at an opposite side of the dielectric substrate, the groove comprises a through groove, and the UWB antenna is arranged in the through groove.

3. The terminal rear cover according to claim 1- or 2, wherein the UWB antenna comprises a conductive unit and a dielectric substrate, and the conductive unit is arranged at a side of the dielectric substrate; and
the groove comprises a recess, a bottom wall of the recess is attached to a side of the dielectric substrate facing away from the conductive unit, and the UWB antenna is grounded through the metal decoration frame.

4. The terminal rear cover according to claim 2, wherein the conductive unit comprises a plurality of elongated grooves recessed inwardly from at least one side edge.

5. The terminal rear cover according to claim 2, wherein the UWB antenna operates in a fifth channel and a ninth channel of a UWB frequency band, a center frequency of the fifth channel is 6.5 GHZ, and a center frequency of the ninth channel is 8 GHz.

6. The terminal rear cover according to claim 5, wherein each conductive unit is substantially in a square shape, an equivalent length of the conductive unit in a first direction is one-half of a wavelength of the center frequency of the fifth channel, an equivalent length of the conductive unit in a second direction is one-half of a wavelength of the center frequency of the ninth channel, and the first direction is substantially perpendicular to the second direction.

7. The terminal rear cover according to claim 2, wherein each conductive unit is substantially in a square shape, and a corner of the conductive unit is configured to be electrically coupled to a feed end.

8. The terminal rear cover according to claim 2, wherein the dielectric substrate comprises a liquid crystal polymer substrate.

9. The terminal rear cover according to claim 1, further comprising:
a protective piece arranged at a side of the metal decoration frame, and the protective piece covering the metal decoration frame.

10. An electronic device, comprising:
a camera module comprising at least one lens; and
a terminal rear cover, comprising:
a rear cover body comprising an opening;
a metal decoration frame coupled to the rear cover body and covering the opening, the metal decoration frame comprising a groove and at least one light passing opening, and the groove being spaced from each light passing opening; and
a UWB antenna embedded in the groove,
wherein each light passing opening is arranged corresponding to at least one lens.

11. The terminal rear cover according to claim 1, wherein the opening penetrates through the rear cover body.

12. The terminal rear cover according to claim 1, wherein the opening is in a shape of a ring or a square.

13. The terminal rear cover according to claim 1, wherein the rear cover body includes a metal rear cover body, a plastic rear cover body, or a glass rear cover body.

14. The terminal rear cover according to claim 1, wherein the metal decoration frame is coupled to an inner ring of the opening.

15. The terminal rear cover according to claim 1, wherein the metal decoration frame is coupled to an outer side of the rear cover body surrounding the opening.

16. The terminal rear cover according to claim 2, wherein the metal grounding plate is exposed relative to the rear cover body.

17. The terminal rear cover according to claim 3, wherein an opening direction of the recess is toward an inner side of the terminal rear cover.

18. The terminal rear cover according to claim 3, wherein an opening direction of the recess is toward an outer side of the terminal rear cover.

19. The terminal rear cover according to claim 2, wherein a plurality of conductive units are arranged on the dielectric substrate, and the plurality of conductive units are spaced from each other.

20. The terminal rear cover according to claim 9, wherein the protective piece adopts a light transmission protective piece.
